(19) United States
(12) Patent Application Publication
(10) Pub. No.: US 2017/0327325 A1
(43) Pub. Date: Nov. 16, 2017

(54) Horse And Saddle Transfer Apparatus For Shipping Containers And Method Of Operation

(71) Applicant: EagleRail Container Logistics, LLC, Chicago, IL (US)

(72) Inventors: Kevin Russell, Roanoke, VA (US); Micheal Scimeca, Beverly Hills, MI (US)

(21) Appl. No.: 15/595,924

(22) Filed: May 15, 2017

Related U.S. Application Data
(60) Provisional application No. 62/337,313, filed on May 16, 2016.

(51) Int. Cl. B65G 63/00; F16M 11/18; F16M 11/04; F16M 11/42; B66C 19/00

(52) U.S. Cl. CPC B65G 63/004; F16M 11/425; B66C 19/002; F16M 11/046; F16M 11/18

(57) ABSTRACT

An apparatus and method transfer a shipping container from a first dockside unloaded position to a second transporting position. A horse-and-saddle assembly is mounted on a pair of transversely spaced rails, and includes a horse member with roller mechanisms cooperating with the rails. A saddle member includes a mounting frame capable of moving transversely upon the horse member. The saddle member is configured to carry the shipping container mounted thereon. A carrier suspended from an overhead monorail is movable along a track extending from the monorail. Once deposited in the saddle member mounting frame, the shipping container in the mounting frame is urged to a position from which lifting devices mounted onto the saddle frame raises the shipping container from the mounting frame. The shipping container is carried while suspended from the overhead monorail carrier to a desired transfer or storage location.

### CROSS-REFERENCE TO RELATED APPLICATION

The present application claims priority benefits from U.S. provisional patent application Ser. No. 62/337,313 filed on May 16, 2016, entitled “Horse and Saddle Transfer Apparatus for Shipping Containers and Method of Operation”. The '313 provisional application is hereby incorporated by reference herein in its entirety.

### FIELD OF INVENTION

The present invention relates to the transfer and movement of shipping containers in port facilities. In particular, the present invention relates to an apparatus and method for transferring shipping containers from a dockside position, or a terminal/yard area, after being unloaded from a container ship to a position from which the shipping container can be transported to a desired location within the port facility and other nearby container handling facilities.

### BACKGROUND OF THE INVENTION

Approximately 90% of non-bulk cargo worldwide is transported via intermodal containers (ISO containers) arranged on ships. When these containers arrive at ports (either by land or by sea) they must be moved onto or off of the ships, trains, and trucks.

Transferring containers from one mode of transportation to another is time and energy intensive. Loading/unloading ships is often conducted at the ground level with various mechanical machines such as cranes, trucks, forklifts, and straddle carriers. Often these machines burn fossil fuels and are not efficient.

One particular problem with current methods for transferring intermodal shipping containers is that they require a large amount of ground space for maneuvering the containers into place. ISO containers can be up to 53 feet (16.15 meters) long, and can weigh in the range of 35-40 tons (31.8-36.3 metric tons). Ground space is often a premium at and around busy ports. Another problem with current methods for transferring ISO containers is that the large amount of time taken to unload ships often leads to port congestion and container backlog.

To alleviate some of these problems, the use of overhead rail transportation systems has been suggested. Overhead rail systems have their own particular types of challenges, particularly where the overhead transportation system comprises a monorail. An overhead monorail solution provides advantages that would significantly improve container port operations.

One particularly problematic aspect associated with current equipment for handling intermodal shipping containers is the transferring of the shipping containers from one transport system in the port facility to another transport system. Conventional container transferring equipment can be cumbersome, difficult to operate, and prone to instability, particularly when manipulating large and heavy containers. Moreover, conventional container transferring equipment is generally not suited to close-tolerance positioning for the alignment of shipping containers with the carrier portion of the transport system to facilitate the exchange of the shipping container from one transport system to another.

### SUMMARY OF THE INVENTION

An apparatus transfers a shipping container to/from an unloaded position from/to a carrier suspended from an overhead monorail. The apparatus comprises:
(a) a horse-and-saddle assembly comprising:
   (1) a horse member comprising:
      (i) a pair of laterally spaced beams extending transversely between the unloaded position to a position from which the shipping container can be lifted by the overhead monorail carrier, the transverse beams interconnected at their respective ends by lateral connectors; and
      (ii) a plurality of legs extending downwardly from the transverse beams, each of the legs having a roller mechanism extending downwardly,
   (2) a saddle member comprising:
      (i) a mounting frame capable of moving transversely upon the transverse beams, the mounting frame configured to carry the shipping container mounted thereon;
      (ii) a lifting mechanism to elevate a container above the frame of the saddle;
(b) a carrier suspended from an overhead monorail, the carrier movable along a track extending from the monorail, the carrier configured to lift and carry a shipping container to a desired transfer or storage location.

In one embodiment, the saddle member is capable of accommodating a plurality of shipping containers. The plurality of shipping containers can be a pair of shipping containers. The shipping containers can be of substantially equal dimensions.

In one embodiment, the horse-and-saddle assembly is moveable laterally such that the saddle member can be positioned to receive a shipping container deposited from a desired position above the saddle member.

In one embodiment, the surface is a dock and the horse-and-saddle assembly is moveable laterally along a pair of spaced rails from a first position to a second position on the surface. When the surface is a dock, the shipping container is placed in the unloaded position by an overhead crane.

A method transfers a shipping container from a first dockside unloaded position to a second transporting position. The method comprises:
(a) mounting a horse-and-saddle assembly on pair of transversely spaced rails, the horse-and-saddle assembly comprising:
   (1) a horse member having a plurality of downwardly extending roller mechanisms capable of cooperating with the rails;
   (2) a saddle member comprising a mounting frame capable of moving transversely upon the horse member, the saddle member configured to carry the shipping container mounted thereon, and capable of lifting and lowering the container;
(b) suspending a carrier from an overhead monorail, the carrier movable along a track extending from the monorail;
(c) depositing the shipping container in the saddle member mounting frame;
(d) urging the shipping container in the mounting frame to a position from which the saddle can lift the shipping container up to the carrier from the mounting frame;
(e) carrying the shipping container while suspended from the carrier to a desired transfer or storage location.

In one embodiment of the method, the shipping container is deposited in the saddle member mounting frame by an overhead crane.

In one embodiment of the method, the horse-and-saddle assembly is a first horse-and-saddle assembly. The method further comprising mounting a second horse-and-saddle assembly on the pair of transversely spaced rails, and alternatingly depositing a shipping container from the overhead crane to one of the saddle members, and lifting another shipping container from the other of the saddle members up to the overhead monorail carrier.

### BRIEF DESCRIPTION OF THE DRAWINGS

FIG. 1 is a perspective view of a port facility, showing in the background a plurality of ship-to-shore cranes positioned to unload shipping containers from a container ship, and showing in the foreground an overhead monorail assembly with suspended carriers for transporting shipping containers from an unloaded position on the dock to a desired location in the port facility.

FIG. 2 is a side elevation view of horse-and-saddle system for transferring shipping containers from an unloaded position on the dock beneath the ship-to-shore crane to a position from which a carrier suspended from an overhead monorail assembly, the saddle can lift the shipping container for attachment to the carrier and subsequent transporting to a desired location in the port facility.

FIGS. 3A and 3B are side elevation views of the horse-and-saddle assembly of FIG. 2, which transfers a shipping container from an unloaded position at one end of the assembly to a position on the other end of the assembly and lifts the shipping container for attachment to a carrier suspended from an overhead monorail assembly. FIG. 3A shows the horse-and-saddle assembly with the saddle empty. FIG. 3B shows the horse-and-saddle assembly with a shipping container mounted in the saddle.

FIGS. 4A and 4B are end elevation views of the horse-and-saddle assembly of FIG. 2, 3A and 3B. FIG. 4A shows the horse-and-saddle assembly with the saddle empty. FIG. 4B shows the horse-and-saddle assembly with a shipping container mounted in the saddle.

FIGS. 5A and 5B are top views of the horse-and-saddle assembly of FIGS. 2, 3A, 3B, 4A and 4B. FIG. 5A shows the horse-and-saddle assembly with the saddle empty. FIG. 5B shows the horse-and-saddle assembly with a shipping container mounted in the saddle.

FIG. 6 is an end elevation view of shipping container being lifted by the saddle of a horse-and-saddle assembly to a carrier suspended from an overhead monorail assembly.

FIG. 7 is a top view of the horse-and-saddle assembly of FIGS. 2, 3A, 3B, 4A and 4B, showing the horse-and-saddle assembly with a pair of half-length (typically 20-foot length) shipping containers mounted in the saddle.

FIG. 8 is an end view of the horse-and-saddle assembly of FIG. 7, showing the horse-and-saddle assembly with a pair of half-length shipping containers mounted in the saddle.

FIG. 9A is an end elevation view of one of the half-length shipping containers of FIG. 8 being lifted by the saddle of a horse-and-saddle assembly to a carrier suspended from an overhead monorail assembly.

FIG. 9B is an end elevation view of the other of the half-length shipping containers of FIG. 8 being lifted by the saddle of a horse-and-saddle assembly to a carrier suspended from an overhead monorail assembly.

FIGS. 10A through 10K are a sequence of schematic diagrams showing the steps in the operation of the horse-and-saddle system for transferring shipping containers from a ship-to-shore crane to carriers suspended from an overhead monorail assembly. The horse-and-saddle assembly is shown in a top view. The ship-to-shore crane is shown in a side view. The carriers suspended from the overhead monorail assembly are also shown in a side view.

FIGS. 11A through 11E are a sequence of schematic diagrams showing the steps in the operation of one embodiment of a basic shipping container loader with side cart.

### DETAILED DESCRIPTION OF ILLUSTRATIVE EMBODIMENT(S)

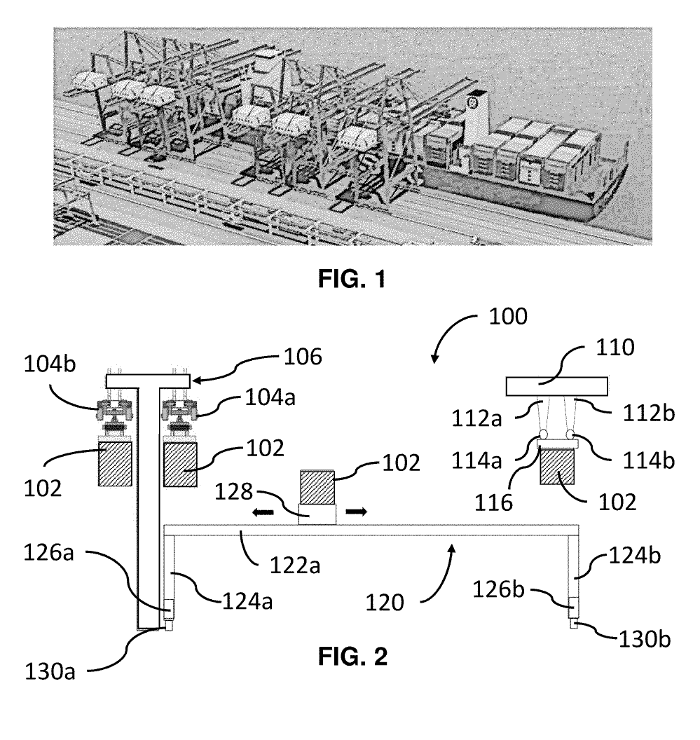

Turning first to FIG. 1, a perspective view of a port facility shows in the background a plurality of ship-to-shore cranes positioned to unload shipping containers from a container ship. In the foreground, an overhead monorail with suspended carriers transports shipping containers from an unloaded position on the dock to a desired location in the port facility.

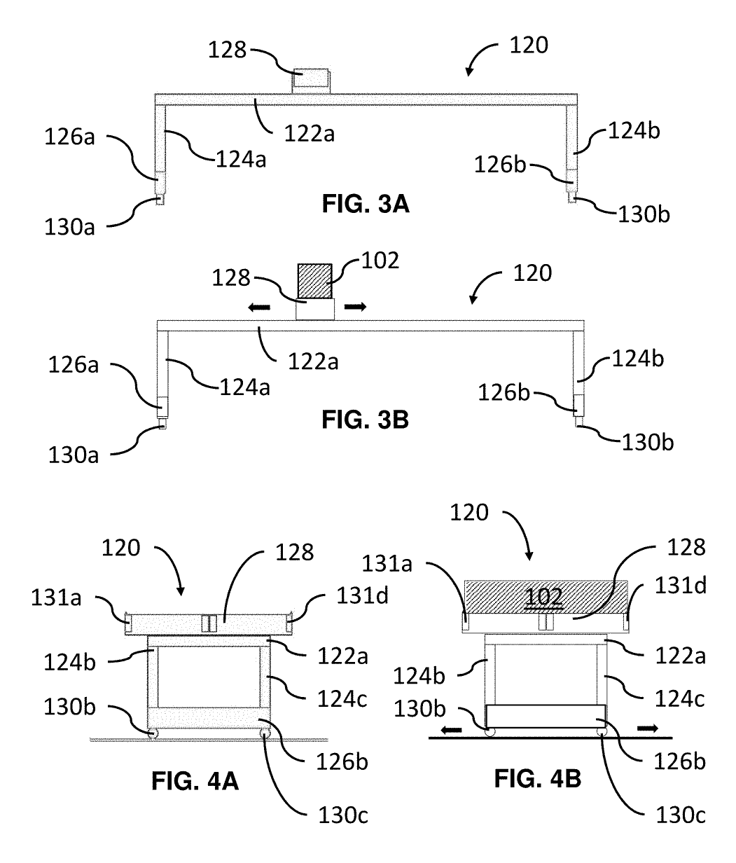

Turning next to FIG. 2, horse-and-saddle system 100 transfers shipping containers 102 from an unloaded position beneath ship-to-shore crane 110 to a position from which one of a pair of carriers 104a and 104b suspended from an overhead monorail assembly 106 can hold and transport a shipping container 102. In addition to a ship-to-shore crane, horse-and-saddle system 100 can also interact with a rail-mounted gantry, a rubber tire gantry or a stationary overhead gantry crane. Once lifted up to carrier 104a, overhead monorail assembly 106 transports shipping container 102 to a desired location in the port facility.

As shown in FIG. 2, crane 110 has a pair of downwardly extending cables 112a and 112b, from which a shipping container carrier 116 is suspended via a pair of connectors 114a and 114b.

Horse-and-saddle system 100 includes a horse-and-saddle assembly 120, which in FIG. 2 consists of a horse member 120 and a saddle 128. Horse member 120 consists of a transverse beam 122a and a pair of oppositely disposed legs 124a and 124b extending downwardly from each end of transverse beam 122a. Lateral beams 126a and 126b extend between legs 124a and 124b, respectively, and a pair of legs (not shown) on the laterally opposite side of horse-and-saddle assembly 120.

As further shown in FIG. 2, rollers 130a and 130b extend downwardly from the lower ends of lateral beams 126a and 126b, respectively. Rollers 130a and 130b enable horse-and-saddle assembly 120 to travel on a pair of rails (not shown) embedded in the surface of the grade level on which the shipping containers are unloaded.

In horse-and-saddle assembly 120 in FIG. 2, saddle 128 travels transversely in the directions represented by the arrows adjacent saddle 128. The movement of saddle 128 can be provided by a motorized mechanism (not shown).

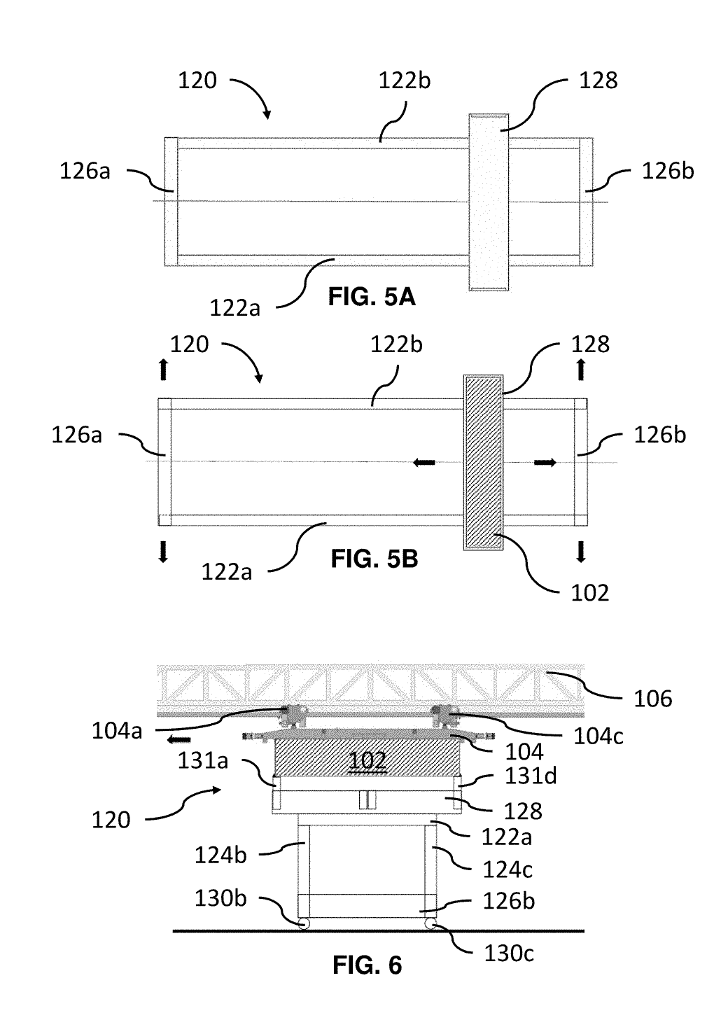

FIG. 3A shows a side view of horse-and-saddle assembly 120 in isolation with respect to the other components of system 100. The individual components of horse-and-saddle assembly 120 are numbered consistently with the equivalent components described above with respect to FIG. 2. In FIG. 3B, a side view of horse-and-saddle assembly 120 is shown with a shipping container 102 mounted in saddle 128. In horse-and-saddle assembly 120 in FIG. 3B, saddle 128 travels transversely in the directions represented by the arrows adjacent saddle 128.

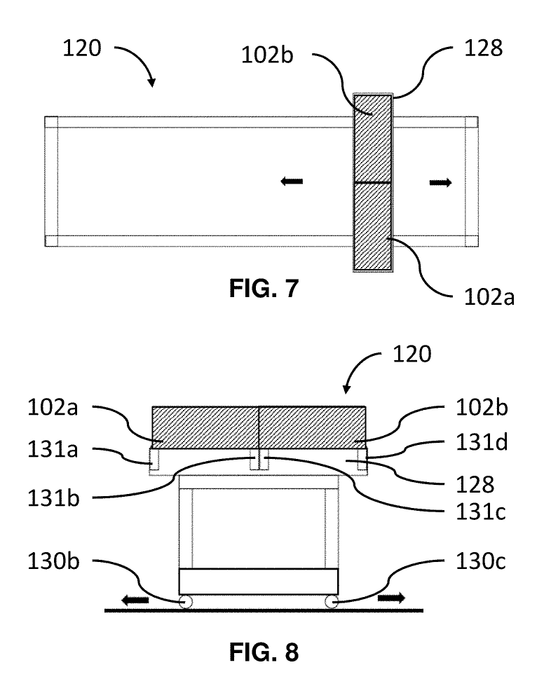

FIG. 4A shows an end view of horse-and-saddle assembly 120 in isolation with respect to the other components of system 100. As in FIG. 3A, the individual components of horse-and-saddle assembly 120 are numbered consistently with the equivalent components described above with respect to FIG. 3A. Lifting mechanisms 131a, 131d are in their lowered positions awaiting the positioning of a shipping container on the top of saddle 128.

In FIG. 4B, an end view of horse-and-saddle assembly 120 is shown with a shipping container 102 mounted in saddle 128. In horse-and-saddle assembly 120 in FIG. 4B, saddle 128 travels transversely in the directions represented by the arrows adjacent rollers 130a and 130c. Lifting mechanisms 131a, 131d remain in their lowered positions.

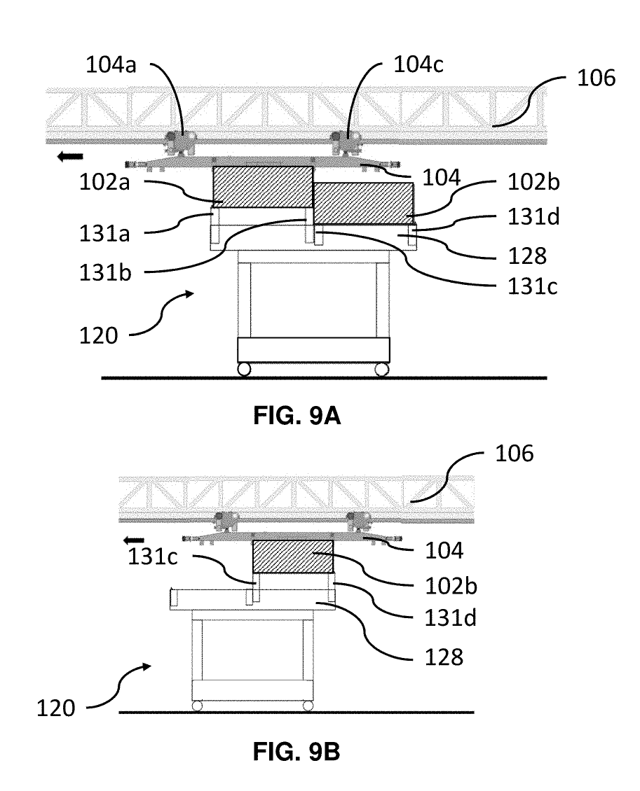

FIG. 5A shows a top view of horse-and-saddle assembly 120 in isolation with respect to the other components of system 100. As in FIGS. 3A and 4A, the individual components of horse-and-saddle assembly 120 are numbered consistently with the equivalent components described above with respect to FIGS. 3A and 4A. As further shown in FIG. 5A, horse-and-saddle assembly 120 has a transverse beam 122b, which is the oppositely disposed counterpart of transverse beam 122a. In FIG. 5B, a top view of horse-and-saddle assembly 120 is shown with a shipping container 102 mounted in saddle 128. In horse-and-saddle assembly 120 in FIG. 5B, saddle 128 travels transversely in the directions represented by the arrows adjacent saddle 128. As further shown, saddle 128 travels laterally in the directions represented by the arrows adjacent lateral beams 126a and 126b.

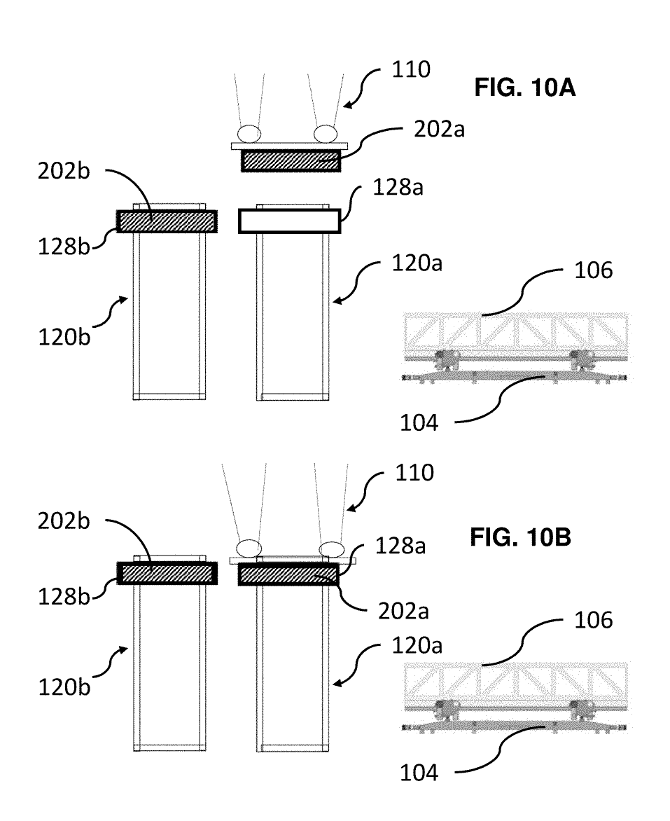

FIG. 6 shows shipping container 102 being lifted from saddle 128 of horse-and-saddle assembly 120 by lift mechanisms 131a, 131d onto a carrier 104, which is suspended from overhead monorail assembly 106 by motorized wheel mechanisms 104a and 104c. As in previous figures, the individual components of horse-and-saddle assembly 120 are numbered consistently with the equivalent components described above with respect to the previous figures. As further shown in FIG. 6, carrier travels transversely in the direction represented by the arrow just below overhead monorail assembly 106.

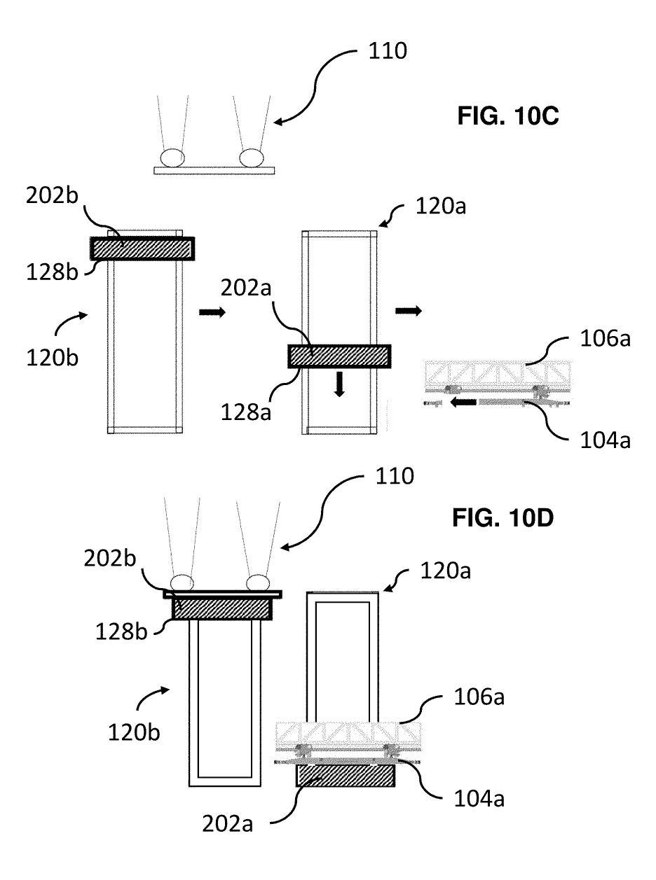

In FIG. 7, horse-and-saddle assembly 120 is shown with a pair of half-length shipping containers 102a and 102b mounted in saddle 128. As in FIG. 5B, saddle 128 travels transversely in the directions represented by the arrows adjacent saddle 128.

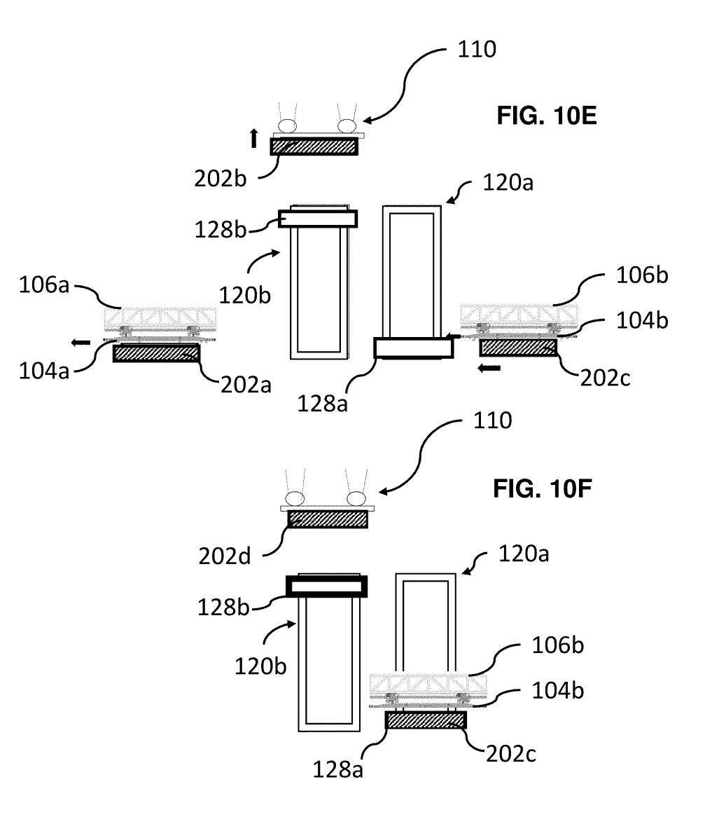

In FIG. 8, horse-and-saddle assembly 120 is shown with a pair of half-length shipping containers 102a and 102b mounted in saddle 128. As in FIG. 4B, saddle 128 travels laterally in the directions represented by the arrows adjacent rollers 130a and 130c. Lifting mechanisms 131a, 131b are in their lowered positions beneath shipping container 102a on the left side of saddle 128. Lifting mechanisms 131c, 131d are in their lowered positions beneath shipping container 102b on the right side of saddle 128.

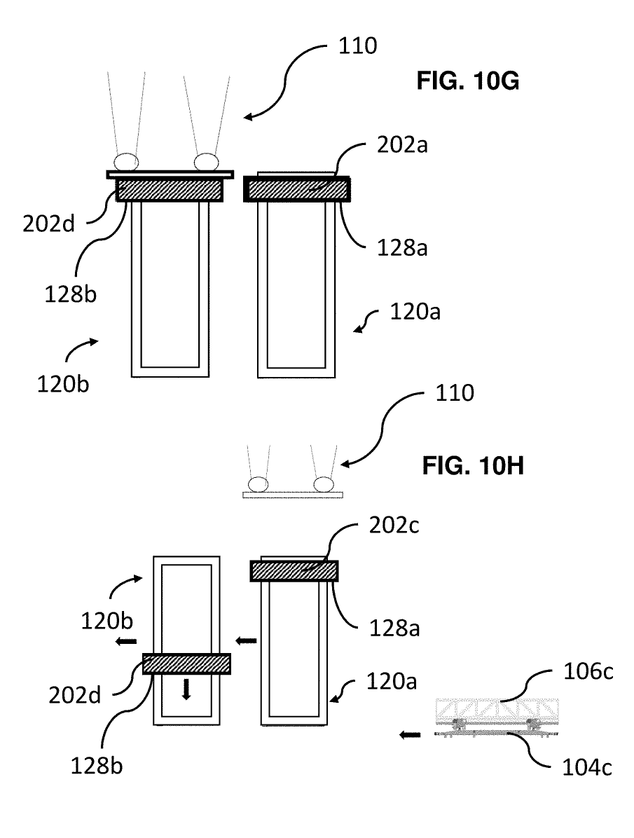

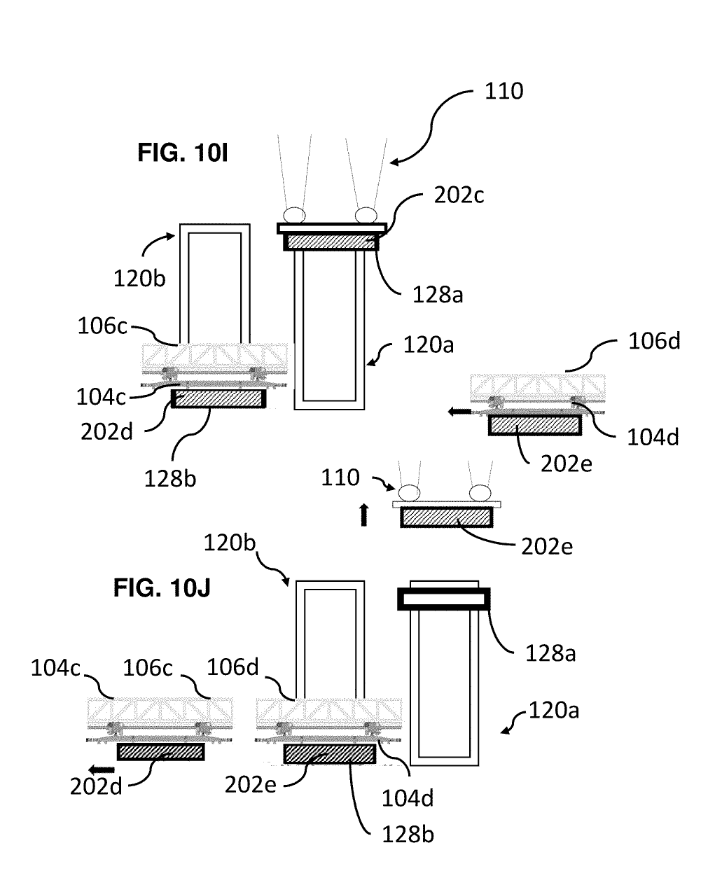

In FIG. 9A, half-length shipping container 102a is shown being lifted from saddle 128 of horse-and-saddle assembly 120 by lifting mechanisms 131a, 131b onto carrier 104, which is suspended from overhead monorail assembly 106.

In FIG. 9B, half-length shipping container 102b is shown being lifted from saddle 128 of horse-and-saddle assembly 120 by lifting mechanisms 131c, 131d onto carrier 104. Lifting mechanisms 131a, 131b are shown in their retracted positions. As further shown in FIG. 9A, carrier 104 travels laterally in the direction represented by the arrow just below overhead monorail assembly 106.

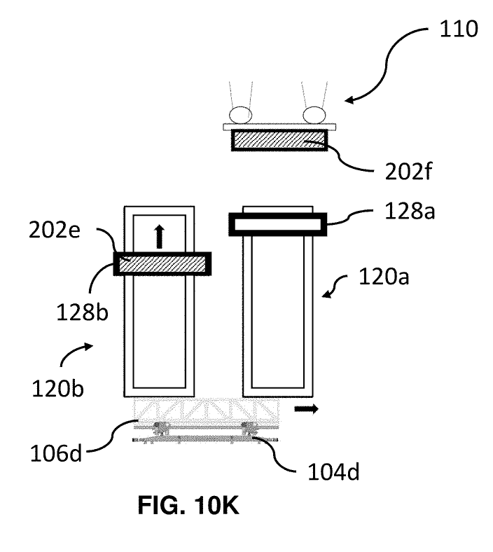

FIGS. 10A through 10K are a sequence of diagrams showing the steps in the operation of the present horse-and-saddle system for transferring shipping containers from a ship-to-shore crane to carriers suspended from an overhead monorail assembly. A pair of horse-and-saddle assemblies 120a and 120b is shown in a top view. Crane 110 is shown in a side view. The carriers suspended from the overhead monorail assembly are also shown in a side view.

In FIG. 10A, crane 110 carries shipping container 202a to a position that aligns vertically with empty saddle 128a of horse-and-saddle assembly 120b. Empty carrier 104a suspended from overhead monorail assembly 106 is shown as standing by in FIG. 10A.

In FIG. 10B, crane 110 deposits shipping container 202a within saddle 128a.

In FIG. 10C, shipping container 202a, which is mounted within saddle 128a, is moved transversely along horse-and-saddle assembly 120a away from the position at which crane 110 deposited shipping container 202a on horse-and-saddle assembly 120a. Concurrently, horse-and-saddle assembly 120a is moved laterally away from the position at which crane 110 deposited shipping container 202a on horse-and-saddle assembly 120a. Meanwhile, horse-and-saddle assembly 120b is moved laterally toward a position that aligns vertically with crane 110. Empty carrier 104a suspended from overhead monorail assembly 106a is shown as travelling toward horse-and-saddle assembly 120a.

In FIG. 10D, shipping container 202a is shown as being lifted by horse-and-saddle assembly 120a onto carrier 104a suspended from overhead monorail assembly 106a. Concurrently, shipping container 202b is shown as being lifted from horse-and-saddle assembly 120b by crane 110.

In FIG. 10E, shipping container 202b is lifted away from horse-and-saddle assembly 120b by crane 110, in some instances to be loaded onto a container ship. Concurrently, shipping container 202a is carried away from the horse-and-saddle assemblies, in the direction of the adjacent arrow, by carrier 104a suspended from overhead monorail assembly 106a. Meanwhile, a new shipping container 202c is carried toward horse-and-saddle assembly 120a, with saddle 128a empty, by carrier 104b suspended from overhead monorail assembly 106b in the direction of the adjacent arrow.

In FIG. 10F, shipping container 202c is deposited within saddle 128a by the lift device 131 (not shown in FIG. 10F) from a new carrier 104b suspended from overhead monorail assembly 106b. Concurrently, crane 110 carries a new shipping container 202d to a position that aligns vertically with empty saddle 128b.

In FIG. 10G, crane 110 deposits shipping container 202d within saddle 128b. Concurrently, saddle 128a carrying shipping container 202c is moved transversely toward the position from which crane 110 can lift shipping container 202c from saddle 128a.

In FIG. 10H, horse-and-saddle assemblies 120a and 120b are both moved in the direction of the adjacent arrows, so that shipping container 202c within saddle 128a is positioned in alignment with crane 110.

In FIG. 10I, crane 110 attaches to shipping container 202c mounted within saddle 128a. Concurrently, shipping container 202d is deposited within saddle 128b by lifting device 131 (not shown in FIG. 10I) from carrier 104c suspended from overhead monorail assembly 106c. Meanwhile, new carrier 104d carries new shipping container 202e toward saddle 128b, which becomes empty once shipping container 202d is carried away from horse-and-saddle assembly 120b.

In FIG. 10J, crane 110 lifts shipping container from within saddle 128a. Concurrently, shipping container 202d is carried away from horse-and-saddle assembly 120b by carrier 104c, in the direction of the adjacent arrow. Meanwhile, shipping container 202e is deposited within saddle 128a by lifting device 131 (not shown in FIG. 10J) from carrier 104d.

In FIG. 10K, shipping container 202e, which is mounted within saddle 128b, is moved transversely along horse-and-saddle assembly 120a away from the position at which carrier 104d previously deposited shipping container 202e on horse-and-saddle assembly 120b. Concurrently, crane 110 carries new shipping container 202f to a position that aligns vertically with empty saddle 128a. Meanwhile, carrier 104d suspended from overhead monorail assembly 106d is moved away from the horse-and-saddle assemblies 120a and 120b, in the direction of the adjacent arrow. Finally, once saddle 128b carrying shipping container 202e has travelled in the direction of the adjacent arrow to the end of horse-and-saddle assembly 120b, the sequence that began with FIG. 10A is repeated.

The sequence of operation in FIGS. 10A through 10K enables twice the rate of containers moved by the ship-to-shore crane. Using two horse-and-saddle systems working in a well-coordinated manner allows the ship-to-shore crane move one container from the ship to a horse-and-saddle system then pick another container from the other horse-saddle system to move this container to the ship.

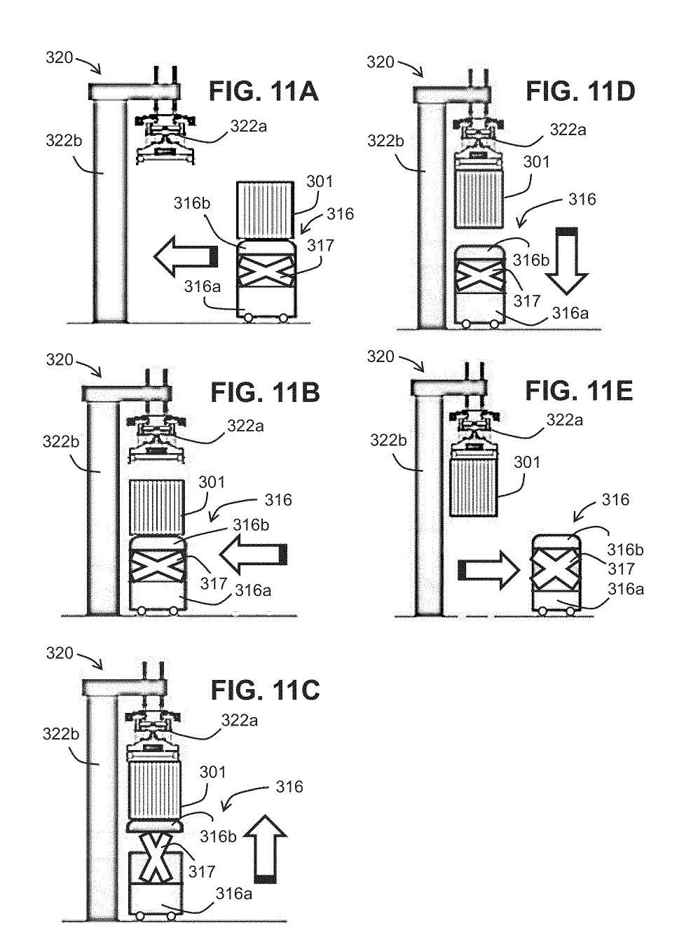

FIGS. 11A through 11E are a sequence of schematic diagrams showing the steps in the operation of a lift-and-loader 316 for transferring a shipping container 301 to an overhead monorail transport assembly 320. Overhead monorail transport assembly 320 has movable shipping container carriers suspended therefrom, one of which is shown in FIGS. 11A through 11E as monorail carrier 322a, which are movable on a track mounted at the top of monorail stanchion 322b.

In FIG. 11A, lift-and-loader 316 is shown in a side view. A shipping container 301 is deposited onto the top portion 316b of lift-and-loader 316. A scissor lift 317 is extendable between the bottom and top portions 316a and 316b of lift-and-loader 316. Scissor lift 317 can be actuated by a hydraulic or pneumatic mechanism, for example. Actuating scissor lift 317 induces top portion 316b to move upwardly away from bottom portion 316a. The arrow in FIG. 11A depicts the movement of lift-and-loader 316 from the original position where it received shipping container 301 toward the position it will have assumed in FIG. 11B under empty carrier 322a.

In FIG. 11B, lift-and-loader 316 has moved from its original position in FIG. 11A, where it received shipping container 301, to a position directly under empty carrier 322a. The arrow in FIG. 11B depicts the movement of lift-and-loader 316 to the position directly under empty carrier 322a.

In FIG. 11C, lift-and-loader 316 raises shipping container 301 upwardly by actuation of scissor lift 317 to a position closely adjacent to empty carrier 322a. A final alignment with carrier 322a is performed to position storage container 301 for twist-lock engagement with carrier 322a. The arrow in FIG. 11C depicts movement of top portion 316b to position shipping container 301 closely adjacent to carrier 322a.

In FIG. 11D, lift-and-loader 316 is returned to its down position once shipping container 301 is secured onto carrier 322a and twist-lock engagement is verified. The arrow in FIG. 11D depicts movement of top portion 316b downwardly by the retraction of scissor lift 317, until top portion 316b has reassumed a height to receive another shipping container.

In FIG. 11E, empty lift-and-loader 316 travels laterally back to its original, home location, to a position where it can receive another shipping container 301. The arrow in FIG. 11E depicts lateral movement of lift-and-loader 316 from its position for lifting a shipping container onto empty carrier 322a to a position for receiving another shipping container at its home location.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. An apparatus for transferring a shipping container from an unloaded position to a carrier suspended from an overhead monorail, the apparatus comprising:
(a) a horse-and-saddle assembly comprising:
(1) a horse member comprising:
(i) a pair of laterally spaced beams extending transversely between said unloaded position to a position from which said shipping container can be lifted to said overhead monorail carrier, said transverse beams interconnected at their respective ends by lateral connectors; and
(ii) a plurality of legs extending downwardly from said transverse beams, each of said legs having a roller mechanism extending downwardly, each of said roller mechanisms;
(2) a saddle member comprising
(i) a mounting frame capable of moving transversely upon the transverse beams, the mounting frame configured to carry the shipping container mounted thereon;
(ii) a lifting mechanism to elevator a container above the frame of the saddle.
(b) a carrier suspended from an overhead monorail, said carrier movable along a track extending from said monorail, said carrier configured to hold and transport a shipping container to a desired transfer or storage location.

2. The apparatus of claim 1, wherein said saddle member is capable of accommodating a plurality of shipping containers.

3. The apparatus of claim 2, wherein said plurality of shipping containers is a pair of shipping containers.

4. The apparatus of claim 3, wherein said shipping containers are of substantially equal dimensions.

5. The apparatus of claim 1, wherein said horse-and-saddle assembly is moveable laterally such that said saddle member can be positioned to receive a shipping container deposited from a desired position above said saddle member.

6. The apparatus of claim 1, wherein said surface is a dock and said horse-and-saddle assembly is moveable laterally along a pair of spaced rails from a first position to a second position on said surface.

7. The apparatus of claim 1, wherein said surface is a dock and said shipping container is placed in said unloaded position by an overhead crane.

8. A method for transferring a shipping container from a first dockside unloaded position to a second transporting position, the method comprising:
(a) mounting a horse-and-saddle assembly on a pair of transversely spaced rails, said horse-and-saddle assembly comprising:
(1) a horse member having a plurality of downwardly extending roller mechanisms capable of cooperating with said rails;
(2) a saddle member comprising a mounting frame capable of moving transversely upon said horse member, said saddle member configured to carry and lift said shipping container mounted thereon;
(b) suspending a carrier from an overhead monorail, said carrier movable along a track extending from said monorail;
(c) carrying said shipping container while suspended from said carrier to a desired transfer or storage location.

9. The method of claim 8, wherein said shipping container is deposited in said saddle member mounting frame by an overhead crane.

10. The method of claim 9, wherein said horse-and-saddle assembly is a first horse-and-saddle assembly, the method further comprising:
mounting a second horse-and-saddle assembly on said pair of transversely spaced rails;
alternatingly depositing a shipping container from said overhead crane to one of said saddle members, and lifting another shipping container from the other of said saddle members.
